(19) United States
(12) Patent Application Publication
(10) Pub. No.: US 2006/0274364 A1
(43) Pub. Date: Dec. 7, 2006

(54) PROCESS FOR AUTOMATIC DETERMINATION OF AN END VALUE

(76) Inventor: Manfred Hasseler, Hechendorf (DE)

Correspondence Address: NOTARO AND MICHALOS, 100 DUTCH HILL ROAD, SUITE 110, ORANGEBURG, NY, 10962-2100, US

(21) Appl. No.: 11/421,100

(22) Filed: May 31, 2006

(30) Foreign Application Priority Data
Jun. 1, 2005 (EP) 05 011 774.6

(51) Int. Cl. G06F 3/12

(52) U.S. Cl. 358/1.15

(57) ABSTRACT

The present invention relates to a process for automatic determination of an end value which has a lower calculability than those of the state of the art in order to minimize faulty operation. The inventive process consists of the steps of starting with an initial value and waiting for an input signal, determining an instantaneous value by increasing the initial value on receiving a first input signal and starting a timer, increasing the instantaneous value again on receipt of any additional input signal and resetting the timer, and outputting the instantaneous value as an end value when an input signal fails to arrive within the period of time defined by the timer.

The present invention relates to a process for automatic determination of an end value.

Various processes for determining end values are known from the state of the art; in these processes, starting with an initial value within a previously defined period of time, input signals that increase the initial value by either a predetermined amount or by a freely selectable amount may be received. After the period of time has elapsed, the instantaneous value determined by that point in time is output as the end value. An example of such a system is that used by the Internet auction company eBay.

One disadvantage of this system is that the determination is very uniform and therefore very highly calculable.

The object of the present invention is therefore to provide a system that avoids the disadvantages of the state of the art.

This object is achieved by a process comprising the following steps:
a) starting with an initial value and waiting for an input signal,
b) after having received a first input signal, an instantaneous value is determined by increasing the initial value and a timer is started, which defines a period of time,
c) upon receiving further input signals, the instantaneous value is increased each time and the timer is reset each time,
d) if no input signal is received within the period of time defined by the timer, the instantaneous value is output as the end value.

Due to the fact that no predetermined total time for the determination is provided according to the present invention, the uniformity and calculability of the determination are greatly reduced. This results in greater attention being devoted to the process, thereby eliminating or greatly reducing faulty operation.

Calculability is further reduced due to the inventive feature that the initial value and/or the length of the period of time defined by the timer are preselectable and/or step a) is performed under timer control. Due to the preselectability of the initial value, it can be adapted well to a desired end value. If high end values are desired, higher initial values are selected and vice versa. Short periods of time accelerate the process while longer periods of time make the process slower. This inventive feature advantageously makes it possible to adapt the process to a desired end value because high end values are reached more easily in the accelerated process.

The calculability of the process is also reduced due to the fact that a threshold value is preselected, and on reaching this threshold value, the instantaneous value is output as the end value. In conjunction with the duration of the process which is not predetermined, this means a further increase in attention to the process. Means have also been provided so that a random generator is started on reaching the preselected threshold value, the random generator defining an end value such that the process is terminated on reaching this end value.

If, after receiving an input signal, an output signal is output, e.g., in the form of an electronic message such as email or SMS, this advantageously achieves the result that the person using the process is informed about the level of the instantaneous value. This person likewise receives a confirmation that the process is functioning reliably.

In one embodiment of the invention, an output signal is output before the elapse of the period of time defined by the timer. If the person using the process receives another output signal, this advantageously achieves the result that the process can be continued despite inadvertent faulty operation and will not be terminated prematurely by inadvertently overlooking the fact that the period of time has elapsed.

The inventive process takes place as follows, for example:

A user receives via a print medium or an online medium a notice of the start of an inventive process and of the manner in which the process will proceed. He also receives a notice of how he can supply an input signal for the process. For example, the process starts on a certain date at a certain time with input value 0. As soon as an input signal has been sent, e.g., by means of a telephone call, a SMS, a postcard or by clicking on a website, the inventive process determines in real time an instantaneous value by adding a certain amount, e.g. 0.5, to the initial value. This instantaneous value is assigned to the user supplying the input signal, e.g., by automatic call number transfer or automatic input with subsequent compensation in a log-in to a website. The process outputs an output signal, e.g., in the form of email or a SMS to the user, who has previously provided his email address or his postal address. In this way the user learns that his input signal has been processed according to this invention.

This process can be further automated if, on sending the first input signal, the user receives a log-in with a password, so that the users' other input signals can be allocated more rapidly. Simultaneously with processing of the input signal, a timer is started, defining a period of time. This period of time may amount to a few minutes up to several days and is contained in the first reference to the process. Optionally it is also possible not to disclose the period of time so that calculability declines and therefore attention among users increases. With any additional input signal, e.g., additional telephone calls, within the predetermined period of time, a new instantaneous value is determined in the same way and is allocated to the particular caller. According to this invention, this process also outputs an output signal when the predetermined period of time is about to elapse. This output signal is directed to all users or it may be directed to a few selected users, e.g., those who have delivered the last ten input signals. Through this output signal, the process gives the users an opportunity to again use the process and thus prevent them from failing to use it further out of oversight. If there is no additional input signal in the process, then the process is terminated by output of the valid instantaneous value as the end value after the preselected period of time has elapsed. The process sends an output signal with which the end value is transmitted to the last user, so that a purchase contract may be negotiated.

In a variant of the present invention, there is a threshold value which is not disclosed to the users. If the instantaneous value reaches this threshold value, the process is terminated without waiting for the period of time to elapse. Again in this case, the process delivers an output signal regarding the amount of the end value to the last user.

1. A process for automated determination of an end value, consisting of the steps
a) starting with the initial value and waiting for an input signal,
b) when a first input signal is received, an instantaneous value is determined by increasing the initial value and a timer which defines a period of time is started,
c) upon receiving further input signals, the instantaneous value is increased each time and the timer is reset each time,
d) if no input signal is received within the period of time defined by the timer, the instantaneous value is output as the end value.

2. The process according to claim 1, wherein the initial value and/or the length of the period of time defined by the timer is/are preselectable and/or step a) is performed under timer control.

3. The process according to claim 1, wherein a threshold value is preselected such that on reaching this threshold value, the instantaneous value is output as an end value.

4. The process according to claims 1, wherein after reaching a threshold value a random generator is started, defining an end value.

5. The process according to claim 1, wherein an output signal is output after receiving an input signal.

6. The process according to claim 1, wherein an output signal is output before the timer has run down.
